(19) United States
(12) Patent Application Publication
(10) Pub. No.: US 2012/0069309 A1
(43) Pub. Date: Mar. 22, 2012

(54) FLUID HANDLING STRUCTURE, MODULE FOR AN IMMERSION LITHOGRAPHIC APPARATUS, LITHOGRAPHIC APPARATUS AND DEVICE MANUFACTURING METHOD

(75) Inventors: Paul WILLEMS, Eindhoven (NL); Nicolaas Ten Kate, Almkerk (NL); Stephan Koelink, Hoogeloon (NL); Pieter Jacob Kramer, Veldhoven (NL); Anthonie Kuijper, Best (NL); Alexander Nikolov Zdravkov, Eindhoven (NL); Rogier Hendrikus Magdalena Cortie, Ittervoort (NL)

(73) Assignee: ASML NETHERLANDS B.V., Veldhoven (NL)

(21) Appl. No.: 13/214,284

(22) Filed: Aug. 22, 2011

Related U.S. Application Data
(60) Provisional application No. 61/376,167, filed on Aug. 23, 2010.

(51) Int. Cl. G03B 27/52

(52) U.S. Cl. 355/30; 355/77

(57) ABSTRACT

A fluid handling structure successively having, at a boundary from a space configured to contain immersion fluid to a region external to the fluid handling structure: a meniscus pinning feature to resist passage of immersion fluid in a radially outward direction from the space; and a fluid supply opening radially outward of the meniscus pinning feature to supply a fluid soluble in the immersion fluid which on dissolution into the immersion fluid lowers the surface tension of the immersion fluid.

This application claims priority and benefit under 35 U.S.C. §119(e) to U.S. Provisional Patent Application No. 61/376,167, filed on Aug. 23, 2010. The content of that application is incorporated herein in its entirety by reference.

### FIELD

The present invention relates to a fluid handling structure, a module for an immersion lithographic apparatus, a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be foinied on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the present invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, device structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

### SUMMARY

In immersion lithography, the fluid handling structure, such as a localized area fluid handling structure, should be designed to handle high scanning speeds (typically of the substrate) without significant liquid loss from the fluid handling structure, desirably without liquid loss. Some liquid is likely to be lost and left behind on a surface (e.g. substrate or substrate table) facing the fluid handling structure (i.e. a facing surface). If any such liquid collides with a meniscus extending between the facing surface and the fluid handling structure, this may cause inclusion of a gas bubble into the liquid, particularly this may occur at high scan speed. If such a gas bubble finds its way into the path taken by the patterned beam through the immersion liquid, this can affect the passage of the patterned beam and thereby may lead to an imaging defect and is therefore undesirable.

It is desirable, for example, to provide a fluid handling structure in which one or more measures are taken to reduce the chance of imaging error.

According to an aspect, there is provided a fluid handling structure for a lithographic apparatus, the fluid handling structure successively having, at a boundary from a space configured to contain immersion fluid to a region external to the fluid handling structure: a meniscus pinning feature to resist passage of immersion fluid in a radially outward direction from the space; and a fluid supply opening radially outward of the meniscus pinning feature to supply a fluid soluble in the immersion fluid which on dissolution into the immersion fluid lowers the surface tension of the immersion fluid.

According to an aspect, there is provided a fluid handling structure for a lithographic apparatus, the fluid handling structure successively having, at a boundary from a space configured to contain immersion fluid to a region external to the fluid handling structure: a gas knife to resist passage of immersion fluid in a radially outward direction from the space; and a surface tension lowering fluid opening to provide a surface tension lowering fluid radially outward of the gas knife.

According to an aspect, there is provided a fluid handling structure for a lithographic apparatus, the fluid handling structure having: an inner side wall defining a side of an immersion liquid enclosure with a bottom of the immersion liquid enclosure defined, in use, by a facing surface; a first opening in the inner side wall to provide immersion liquid to the immersion liquid enclosure; a second opening in a bottom wall of the fluid handling structure, which, in use, faces the facing surface, to provide a liquid with a lower surface tension to the immersion liquid to a gap between the fluid handling structure and the facing surface; and a meniscus pinning feature resisting passage of liquid in a radially outward direction along the gap, wherein the meniscus pinning feature is radially outward of the second opening.

According to an aspect, there is provided a device manufacturing method comprising projecting a patterned beam of radiation through an immersion liquid confined by a meniscus pinning feature on to a substrate, and supplying a fluid soluble in the immersion liquid which on dissolution into the immersion liquid lowers the surface tension of the immersion liquid at a position radially outward of the meniscus pinning feature.

According to an aspect, there is provided a device manufacturing method comprising projecting a patterned beam of radiation through an immersion liquid confined to a space by a gas knife onto a substrate positioned on a table and lowering surface tension of the immersion liquid radially outward of the gas knife by providing a surface tension lowering fluid radially outwardly of the gas knife.

According to an aspect, there is provided a device manufacturing method comprising: projecting a patterned beam of radiation through an immersion liquid onto a substrate, wherein the immersion liquid is provided to an immersion fluid enclosure defined by an inside wall of a fluid handling structure and the substrate; and providing a second liquid with a lower surface tension to the immersion liquid to a gap between the fluid handling structure and the substrate at a position radially inwardly of a meniscus pinning feature of the fluid handling structure.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts, in cross-section, a barrier member which may be used in an embodiment of the present invention as an immersion liquid supply system;

FIG. 6 is a schematic illustration, in plan, of a meniscus pinning system according to an embodiment of the present invention;

FIG. 7 depicts, in cross-section the meniscus pinning system of FIG. 6 along line VII-VII in FIG. 6 and in a plane substantially perpendicular to a stationary surface under the fluid handling structure;

FIG. 8 depicts, in cross-section, behavior of liquid at an advancing side of the fluid handling structure depicted in FIG. 7;

FIG. 9 depicts, in cross-section, behavior of liquid at a receding side of the fluid handling structure depicted in FIG. 7;

FIG. 10 depicts an alternative receding side of the fluid handling structure of FIG. 7;

FIG. 11 depicts, in cross-section, in a plane substantially perpendicular to a surface under a fluid handling structure, a part of a fluid handling structure according to an embodiment of the present invention; and

FIG. 12 depicts, in cross-section, in a plane substantially perpendicular to a surface under a fluid handling structure, a part of a fluid handling structure according to an embodiment of the present invention.

### DETAILED DESCRIPTION

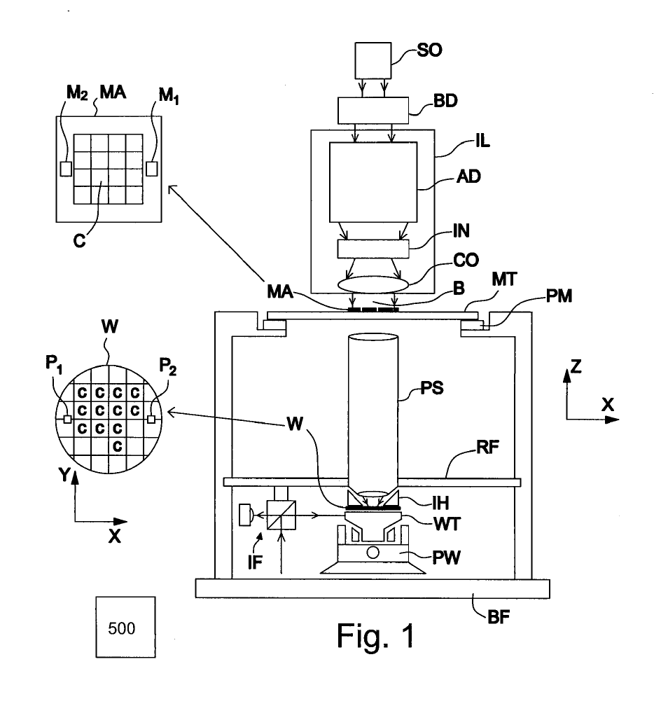

FIG. 1 schematically depicts a lithographic apparatus according to one embodiment of the invention. The apparatus comprises:
an illumination system (illuminator) IL configured to condition a radiation beam B (e.g. UV radiation or DUV radiation);
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. The support structure MT holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AM configured to adjust the angular intensity distribution of the radiation beam. Generally, at least the outer and/or inner radial extent (commonly referred to as a-outer and r-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

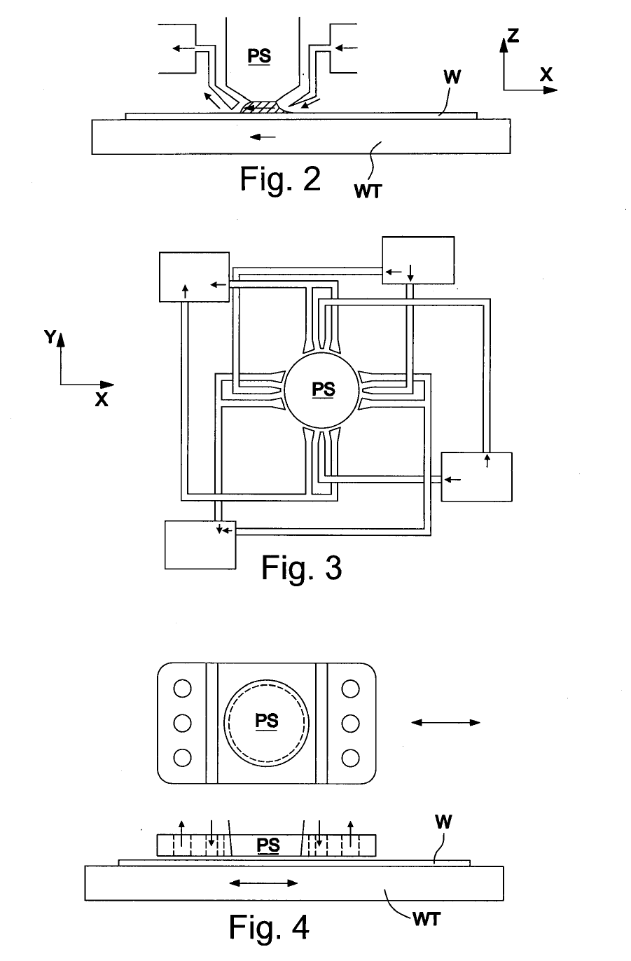

Arrangements for providing liquid between a final element of the projection system and the substrate can be classed into at least two general categories. These are the bath type arrangement and the so called localized immersion system. In the bath type arrangement substantially the whole of the substrate and optionally part of the substrate table is submersed in a bath of liquid. The so called localized immersion system uses a liquid supply system in which liquid is only provided to a localized area of the substrate. In the latter category, the space filled by liquid is smaller in plan than the top surface of the substrate and the area filled with liquid remains substantially stationary relative to the projection system while the substrate moves underneath that area. A further arrangement, to which an embodiment of the invention is directed, is the all wet solution in which the liquid is unconfined. In this arrangement substantially the whole top surface of the substrate and all or part of the substrate table is covered in immersion liquid. The depth of the liquid covering at least the substrate is small. The liquid may be a film, such as a thin film, of liquid on the substrate. Any of the liquid supply devices of FIGS. 2-5 may be used in such a system; however, sealing features are not present, are not activated, are not as efficient as normal or are otherwise ineffective to seal liquid to only the localized area. Four different types of localized liquid supply systems are illustrated in FIGS. 2-5.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet onto the substrate, desirably along the direction of movement of the substrate relative to the final element, and is removed by at least one outlet after having passed under the projection system. That is, as the substrate is scanned beneath the element in a −X direction, liquid is supplied at the +X side of the element and taken up at the −X side.

FIG. 2 shows the arrangement schematically in which liquid is supplied via inlet and is taken up on the other side of the element by outlet which is connected to a low pressure source. The arrows above the substrate W illustrate the direction of liquid flow, and the arrow below the substrate W illustrates the direction of movement of the substrate table. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element. Arrows in liquid supply and liquid recovery devices indicate the direction of liquid flow.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets and outlets can be arranged in a plate with a hole in its center and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). In the cross-sectional view of FIG. 4, arrows illustrate the direction of liquid flow in inlets and out of outlets.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. In an arrangement, the apparatus has only one table, or has two tables of which only one can support a substrate.

PCT patent application publication no. WO 2005/064405 discloses an all wet arrangement in which the immersion liquid is unconfined. In such a system the whole top surface of the substrate is covered in liquid. This may be advantageous because then the whole top surface of the substrate is exposed to the substantially same conditions. This has an advantage for temperature control and processing of the substrate. In WO 2005/064405, a liquid supply system provides liquid to the gap between the final element of the projection system and the substrate. That liquid is allowed to leak (or flow) over the remainder of the substrate. A barrier at the edge of a substrate table prevents the liquid from escaping so that it can be removed from the top surface of the substrate table in a controlled way. Although such a system improves temperature control and processing of the substrate, evaporation of the immersion liquid may still occur. One way of helping to alleviate that problem is described in United States patent application publication no. US 2006/0119809. A member is provided which covers the substrate in all positions and which is arranged to have immersion liquid extending between it and the top surface of the substrate and/or substrate table which holds the substrate.

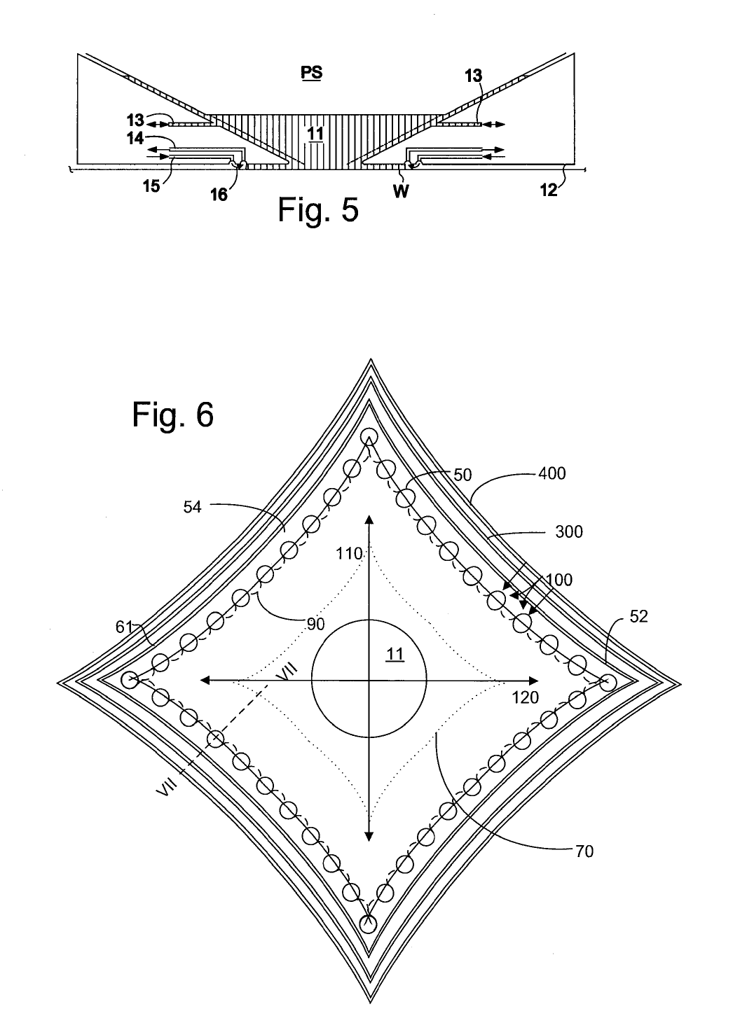

Another arrangement which has been proposed is to provide the liquid supply system with a liquid confinement member which extends along at least a part of a boundary of the space between the final element of the projection system and the substrate table. Such an arrangement is illustrated in FIG. 5. The liquid confinement member is substantially stationary relative to the projection system in the XY plane though there may be some relative movement in the Z direction (in the direction of the optical axis). A seal is formed between the liquid confinement and the surface of the substrate. In an embodiment, a seal is formed between the liquid confinement structure and the surface of the substrate and may be a contactless seal such as a gas seal. Such a system is disclosed in United States patent application publication no. US 2004-0207824.

FIG. 5 schematically depicts a localized liquid supply system with a fluid handling structure 12. The fluid handling structure extends along at least a part of a boundary of the space between the final element of the projection system and the substrate table WT or substrate W. (Please note that reference in the following text to surface of the substrate W also refers in addition or in the alternative to a surface of the substrate table, unless expressly stated otherwise.) The fluid handling structure 12 is substantially stationary relative to the projection system in the XY plane though there may be some relative movement in the Z direction (in the direction of the optical axis). In an embodiment, a seal is formed between the barrier member and the surface of the substrate W and may be a contactless seal such as a fluid seal, desirably a gas seal.

The fluid handling structure 12 at least partly contains liquid in the space 11 between a final element of the projection system PS and the substrate W. A contactless seal 16 to the substrate W may be formed around the image field of the projection system so that liquid is confined within the space between the substrate W surface and the final element of the projection system PS. The space is at least partly formed by the fluid handling structure 12 positioned below and surrounding the final element of the projection system PS. Liquid is brought into the space below the projection system and within the fluid handling structure 12 by liquid inlet 13. The liquid may be removed by liquid outlet 13. The fluid handling structure 12 may extend a little above the final element of the projection system. The liquid level rises above the final element so that a buffer of liquid is provided. In an embodiment, the fluid handling structure 12 has an inner periphery that at the upper end closely conforms to the shape of the projection system or the final element thereof and may, e.g., be round. At the bottom, the inner periphery closely conforms to the shape of the image field, e.g., rectangular, though this need not be the case.

In an embodiment, the liquid is contained in the space 11 by a gas seal 16 which, during use, is formed between the bottom of the fluid handling structure 12 and the surface of the substrate W. The gas seal is formed by gas, e.g. air or synthetic air but, in an embodiment, N₂ or another inert gas. The gas in the gas seal is provided under pressure via inlet 15 to the gap between fluid handling structure 12 and substrate W. The gas is extracted via outlet 14. The overpressure on the gas inlet 15, vacuum level on the outlet 14 and geometry of the gap are arranged so that there is a high-velocity gas flow 16 inwardly that confines the liquid. The force of the gas on the liquid between the fluid handling structure 12 and the substrate W contains the liquid in a space 11. The inlets/outlets may be annular grooves which surround the space 11. The annular grooves may be continuous or discontinuous. The flow of gas 16 is effective to contain the liquid in the space 11. Such a system is disclosed in United States patent application publication no. US 2004-0207824.

The example of FIG. 5 is a so called localized area arrangement in which liquid is only provided to a localized area of the top surface of the substrate W at any one time. Other arrangements are possible, including fluid handling systems which make use of a single phase extractor or a two phase extractor as disclosed, for example, in United States patent application publication no US 2006-0038968. In an embodiment, a single or two phase extractor may comprise an inlet which is covered in a porous material. In an embodiment of a single phase extractor the porous material is used to separate liquid from gas to enable single-liquid phase liquid extraction. A chamber downstream of the porous material is maintained at a slight under pressure and is filled with liquid. The under pressure in the chamber is such that the meniscuses formed in the holes of the porous material prevent ambient gas from being drawn into the chamber. However, when the porous surface comes into contact with liquid there is no meniscus to restrict flow and the liquid can flow freely into the chamber. The porous material has a large number of small holes, e.g. of diameter in the range of 5 to 300 desirably 5 to 50 In an embodiment, the porous material is at least slightly liquidphilic (e.g., hydrophilic), i.e. having a contact angle of less than 90° to the immersion liquid, e.g. water.

Another arrangement which is possible is one which works on a gas drag principle. The so-called gas drag principle has been described, for example, in United States patent application publication nos. US 2008-0212046, US 2009-0279060, and US 2009-0279062. In that system the extraction holes are arranged in a shape which desirably has a corner. The corner may be aligned with the stepping or scanning directions. This reduces the force on the meniscus between two openings in the surface of the fluid handing structure for a given speed in the step or scan direction compared to if the two outlets were aligned perpendicular to the direction of scan.

Also disclosed in US 2008-0212046 is a gas knife positioned radially outside the main liquid retrieval feature. The gas knife traps liquid which gets past the main liquid retrieval feature. Such a gas knife may be present in a so called gas drag principle arrangement (as disclosed in US 2008-0212046), in a single or two phase extractor arrangement (such as disclosed in United States patent application publication no. US 2009-0262318) or any other arrangement.

Many other types of liquid supply system are possible. The present invention is not limited to any particular type of liquid supply system. As will be clear from the description below, an embodiment of the present invention may use any type of localized liquid supply system. An embodiment of the invention is particularly relevant to use with any localized liquid supply system as the liquid supply system.

An embodiment of the present invention will be described with reference to a gas drag extractor fluid handling system. However, the present invention may be used in any other type of fluid handling system. The gas supply opening and outlet opening described below can be provided radially outwardly of meniscus pinning features of any type of fluid handling structure e.g. gas flow (FIG. 5), liquid flow (FIG. 3), porous extractor, etc. In this way, as described below, a large droplet which may cause an imaging defect if it collided with the meniscus extending between the facing surface and the meniscus pinning feature can be adapted so that on collision with the meniscus it does not cause inclusion of a bubble.

FIG. 6 illustrates schematically and in plan the meniscus pinning features of part of a fluid handling structure for use in an embodiment of the invention. The features of a meniscus pinning device are illustrated which may, for example, replace the meniscus pinning arrangement 14, 15, 16 of FIG. 5. The meniscus pinning device of FIG. 6 comprises a plurality of discrete openings 50 arranged in a first line or pinning line. Each of these openings 50 are illustrated as being circular though this is not necessarily the case.

Each of the openings 50 of the meniscus pinning device of FIG. 6 may be connected to a separate under pressure source. Alternatively or additionally, each or a plurality of the openings 50 may be connected to a common chamber or manifold (which may be annular) which is itself held at an under pressure. In this way a uniform under pressure at each or a plurality of the openings 50 may be achieved. The openings 50 can be connected to a vacuum source and/or the atmosphere surrounding the fluid handling structure or system (or confinement structure, barrier member or liquid supply system) may be increased in pressure to generate the desired pressure difference.

In the embodiment of FIG. 6 the openings are fluid extraction openings. The openings 50 are inlets for the passage of gas and/or liquid into the fluid handling structure. That is, the openings may be considered as outlets from the space 11. This will be described in more detail below.

The openings 50 are formed in a surface of a fluid handling structure 12. A surface of, for example, the substrate and/or substrate table, in use, faces the fluid handling structure 12. The surface facing the fluid handling structure 12 may be referred to as a facing surface. In one embodiment the openings are in a flat surface of the fluid handling structure. In another embodiment, a ridge may be present on the surface of the fluid handling structure facing the facing surface. In that embodiment the openings may be in the ridge. In an embodiment, the openings 50 may be defined by needles or tubes. The bodies of some of the needles, e.g., adjacent needles, may be joined together. The needles may be joined together to form a single body. The single body may form the shape which may be cornered.

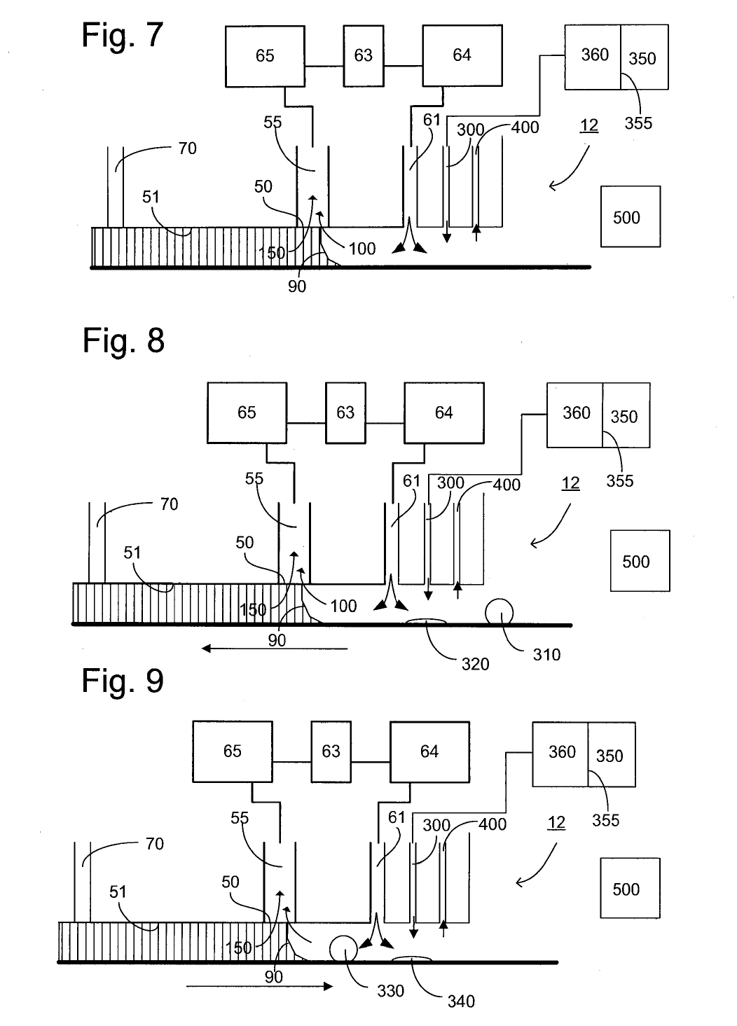

As can be seen from FIG. 7, the openings 50 are the end of a tube or elongate passageway 55, for example. Desirably the openings are positioned such that they face the facing surface (e.g., substrate W) in use. The rims (i.e. outlets out of a surface) of the openings 50 are substantially parallel to a facing surface (e.g., a top surface of the substrate W). The openings are directed, in use, towards the facing surface (e.g., the substrate W and/or substrate table WT configured to support the substrate). Another way of thinking of this is that an elongate axis of the passageway 55 to which the opening 50 is connected is substantially perpendicular (within +/−45°, desirably within 35°, 25° or even 15° from perpendicular) to the facing surface.

Each opening 50 is designed to extract a mixture of liquid and gas. The liquid is extracted from the space 11 whereas the gas is extracted from the atmosphere on the other side of the openings 50 to the liquid. This creates a gas flow as illustrated by arrows 100 and this gas flow is effective to pin the meniscus 90 between the openings 50 substantially in place as illustrated in FIG. 6. The gas flow helps maintain the liquid confined by momentum blocking, by a gas flow induced pressure gradient and/or by drag (shear) of the gas flow on the liquid.

The openings 50 surround the space to which the fluid handling structure supplies liquid. The meniscus may be pinned by the openings 50, during operation.

As can be seen from FIG. 6, the openings 50 may be positioned so as to form, in plan, a cornered shape (i.e. a shape with corners 52). In the case of FIG. 6 the shape is a quadrilateral, such as a rhombus, e.g. a square, with curved edges or sides 54. The edges 54 may have a negative radius. An edge 54 may curve towards the center of the cornered shape, for example along a portion of the edge 54 located away from the corners 52. However, the average of the angle of all points on the edge 54 relative to a direction of relative motion may be referred to as a line of average angle which may be represented by a straight line without curvature.

Principal axes 110,120 of the shape may be aligned with the major directions of travel of the substrate W under the projection system. This helps to ensure that the maximum scan speed is faster than if the openings 50 were arranged in a shape in which the direction of movement is unaligned with an axis of the shape, for example a circular shape. This is because the force on the meniscus between two openings 50 may be reduced if the principal axes are aligned with a direction of relative motion. For example, the reduction may be a factor cos θ. ‘θ’ is the angle of the line connecting the two openings 50 relative to the direction in which the facing surface is moving.

The use of a square shape allows movement in the step and scanning directions to be at a substantially equal maximum speed.

Throughput can be optimized by making the primary axis of the shape of the openings 50 aligned with the major direction of travel of the substrate (usually the scan direction) and to have another axis aligned with the other major direction of travel of the substrate (usually the step direction). It will be appreciated that any arrangement in which θ is different to 90° will give an advantage in at least one direction of movement. Thus, exact alignment of the principal axes with the major directions of travel is not vital.

Radially inwardly of the openings 50 are a plurality of liquid supply openings 70 through which liquid is provided to a gap between the undersurface of the fluid handling structure 12 and the facing surface.

Immersion liquid droplets may escape from the space 11 in which the immersion liquid is confined during relative movement under the space 11 of, for example, a height step in the surface facing the space (such as a gap between an edge of a substrate W and an edge of a recess in the table supporting the substrate or the surface of a sensor), and when the relative speed between the fluid handling structure and the facing surface, e.g. scanning speed, is larger than a critical speed (this might be necessary when a higher scanning speed/throughput is required). Such a critical speed may be dependent on at least one property of the facing surface.

In escaping from the immersion liquid in the space, the droplet breaks from the meniscus 90 of the immersion liquid between the fluid handling structure and a facing surface (such as a substrate W or a substrate table WT which supports the substrate). The meniscus may be pinned to the fluid handling structure 12 by the fluid extraction opening 50 which may extract liquid and gas in a two phase fluid flow. The droplet may escape from a trailing side of the immersion space 11 with respect to the movement of the facing surface.

In moving with the facing surface (with respect to the fluid handling structure 12) the droplet may then encounter a gas knife 61 which directs the droplet back to the liquid extractor. However, sometimes the conditions may be such that the droplet is blocked from moving further away from the meniscus 90 by the gas knife. Sometimes such a droplet may pass beyond the gas knife 61. In an embodiment the droplet has escaped the influence of a component of the fluid handling structure 12. In another embodiment, the droplet will encounter a further extractor and gas knife which may serve to extract and/or block the movement of the droplet away from the meniscus.

When the relative motion between the fluid handling structure 12 and the facing surface in the plane of the facing surface, e.g. the scanning or stepping direction is changed, such a droplet can move relative to the fluid handling structure 12 back towards the liquid meniscus 90. The droplet may at least partly be stopped by a gas knife 61 it first passed when escaping from the meniscus. The droplet may be sufficiently large that it passes the gas knife 61 towards the meniscus 90. The droplet may be extracted by extraction through the extraction opening 50 provided at or at least near the edge or boundary of the immersion liquid confined in the space 11. However, if such a droplet is not extracted completely it can create a bubble on collision with the liquid meniscus 90 of the liquid confined in the space.

The droplet may be insufficiently large and/or have insufficient speed to pass the gas knife 61 towards the meniscus 90. The droplet may merge with one or more droplets which may be small to form a bigger droplet in front of the gas knife 61. In this case, the gas knife 61 may be overloaded with immersion liquid, allowing the merged droplet to pass. Such a droplet will move relative to the fluid handling structure 12 towards the meniscus 90 and may potentially create one or more bubbles.

Radially outwardly of the meniscus pinning features (the outlets 50 and the gas knife 61) a fluid supply opening 300 is provided. The fluid supply opening 300 is configured to supply a fluid soluble in the immersion liquid (e.g. a liquid supplied as a vapor in a carrier gas) to lower the surface tension of the immersion fluid into which it dissolves. Therefore, the surface tension of the meniscus of droplets which pass the gas knife 61 on the receding side (as illustrated in FIG. 9) or droplets which approach the gas knife 61 on the approaching side (FIG. 8) is reduced. As a result of a reduction in surface tension the height of the droplet decreases.

Droplets with a lower height, on collision with the meniscus 90, may be less likely to cause inclusion of a bubble in liquid than droplets which have a higher height. Therefore, provision of a fluid soluble in immersion liquid and capable of lowering the surface tension of a meniscus of a body of immersion liquid outside of the gas knife 61 reduces the chance of droplet collision with the meniscus 90 (which may lead to bubble inclusion in the space). One or more advantages may result from this. For example, the flow rate of gas out of gas knife 61 may be reduced because the disadvantage of loss of immersion liquid is reduced. A local thermal load which occurs due to evaporation of a droplet and may result in mechanical deformation and/or a drying stain on the facing surface may be reduced because the droplet is spread out as its surface tension is reduced. This spreading out may result in a thermal load which is less localized.

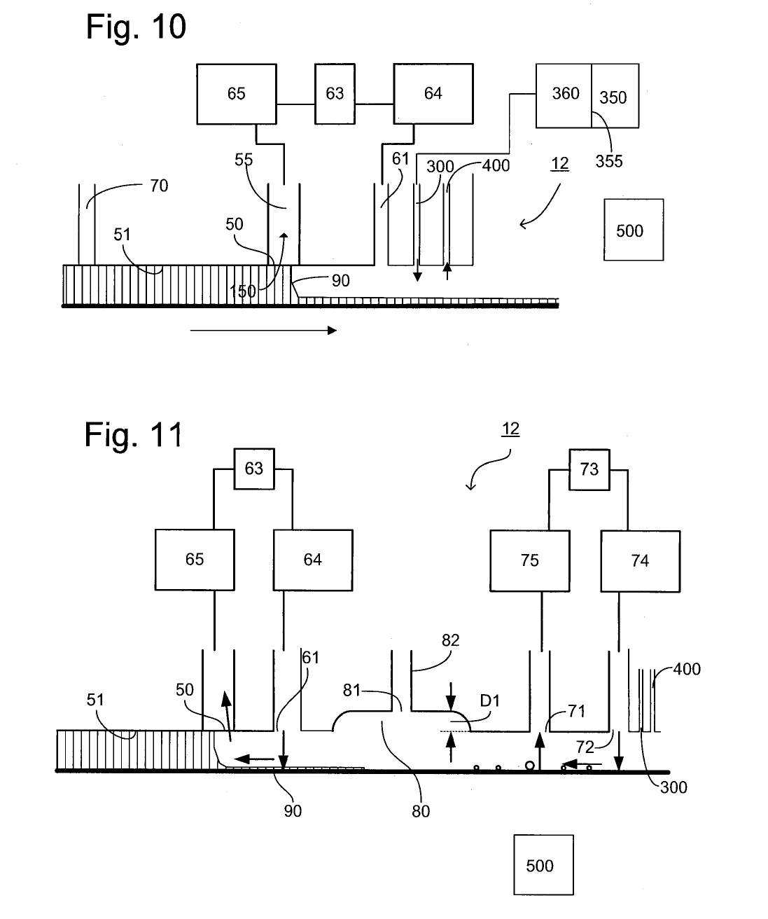

In an embodiment, it is possible to help ensure that a film of liquid (rather than discrete droplets) is left behind on the substrate W after it passes under the fluid handling structure 12. When a liquid film is left behind on the substrate, the film is less likely to break up into droplets because of the lowered surface tension of the meniscus of the immersion liquid. A liquid film may be desirable because this reduces the total number of collisions between liquid on the substrate and the meniscus 90 thus possibly reducing the number of collisions which can lead to bubble formation. That is, a reduction in surface tension increases the time which a film of liquid takes to break up into a plurality of droplets. This is explained further with reference to FIG. 10. Additionally, any thermal load due to evaporation is applied to the facing surface evenly.

As will be appreciated, the fluid supply opening 300 could be used in any type of fluid handling structure 12, such as a localized area fluid handling structure. In any embodiment the fluid supply opening 300 is positioned radially outwardly of the one or more meniscus pinning features which resist the passage of immersion fluid in a radially outward direction from the space 11. With use of the fluid supply opening 300 it is possible to allow the meniscus pinning features to operate in a way in which liquid leaks more easily than otherwise since the deleterious results of leaking liquid are mitigated by the fluid flow from the fluid supply opening 300.

In an embodiment it is desirable to have a shielding device to shield immersion liquid in the space, and in particular the liquid at the meniscus 90, from the fluid supply opening 300. This is because the meniscus pinning features, in particular the openings 50 operate better with a high surface tension of the immersion liquid to pin the meniscus 90 in place. Therefore, it may be undesirable that the fluid which would lower the surface tension of the immersion liquid reaches the meniscus 90.

In the embodiment of FIG. 6 the shielding device is provided by the gas knife aperture 61 which helps ensures that no or little gas from the fluid supply opening 300 reaches the meniscus 90. In an embodiment this is arranged by helping ensure that there is a radially outward flow of gas from the gas knife aperture 61. The gas knife aperture 61 also forms part of the meniscus pinning features of embodiment of FIGS. 6 and 7. In an embodiment, the shielding device is positioned radially inwardly of the fluid supply opening 300 and radially outwardly of one or more of the meniscus pinning features.

The fluid exiting the fluid supply opening 300 destabilizes the meniscus when the gas contacts the meniscus 90. Although the gas knife aperture 61 shields the meniscus 90 from the fluid exiting the fluid supply opening 300, in some circumstances, for example at a trailing edge, the meniscus 90 can move away from the openings 50 and may extend all the way to under the fluid supply opening 300. When this happens the fluid exiting the fluid supply opening 300 will destabilize the meniscus 90 by lowering its surface tension. This makes the resulting film more stable than the film would otherwise be. That is, the film stays a film for longer before breaking up into droplets.

It may be desirable to help ensure that there is a radially outward flow of immersion liquid in the gap between the underside of the fluid handling structure 12 and the facing surface. That is, there is a radially outward flow of immersion liquid at an edge of the space 11. This can be arranged by providing extraction of gas and/or liquid from outside the space 11 through the openings 50. This is the case in the fluid handling structure 12 according to FIG. 6. The outward flow can be further ensured by providing the plurality of openings 70 through which liquid is provided to the gap between the undersurface of the fluid handling structure 12 and the facing surface. The net outward flow can be facilitated by an appropriate selection of flow rates for the supply and extraction of liquid and gas through openings 50, 70 and 61.

It is desirable not to allow the fluid from the fluid supply opening 300 to escape to the atmosphere (e.g. because it may be deleterious to the environment or apparatus or be hazardous e.g. flammable). Therefore, in an embodiment an outlet opening 400 is provided radially outward of the fluid supply opening 300. The outlet opening 400 is for the extraction therethrough of fluid from the fluid supply opening 300. The outlet opening 400 is attached to an underpressure source so that the fluid may be removed. The fluid may be disposed of in a safe manner and/or recycled.

The openings 300, 400 may each be in the form of one continuous aperture or a plurality of discrete apertures in a line.

In an embodiment, fluid supply opening 300 and/or outlet opening 400 may be provided in a member separate to the fluid handling structure 12. In an embodiment the fluid supply opening 300 and/or outlet opening 400 are provided radially outwardly of the fluid handling structure 12.

FIG. 7 illustrates that the opening 50 (as well as openings 300, 400) is provided in the undersurface 51 of the fluid handling structure 12. Arrow 100 shows the flow of gas from outside of the fluid handling structure 12 into a passageway 55 associated with the opening 50. Arrow 150 illustrates the passage of liquid from the space into the opening 50. The passageway 55 and opening 50 are designed so that two phase extraction (i.e. gas and liquid) desirably occurs in an annular flow mode. In annular gas flow, gas may substantially flow through the center of the passageway 55 and liquid may substantially flow along the wall(s) of the passageway 55. A smooth flow with low generation of pulsations results.

There may be no meniscus pinning features radially inwardly of the openings 50. The meniscus is pinned between the openings 50 with drag forces induced by gas flow into the openings 50. A gas drag velocity of greater than about 15 m/s, desirably 20 m/s is sufficient. The amount of evaporation of liquid from the facing surface may be reduced thereby reducing both splashing of liquid as well as thermal expansion/contraction effects.

A plurality of discrete needles (which may each include an opening 50 and a passageway 55), for example at least thirty-six (36), each with a diameter of 1 mm and separated by 3.9 mm may be effective to pin a meniscus. In an embodiment, 112 openings 50 are present. The openings 50 may be square, with a length of a side of 0.5 mm, 0.3 mm, 0.2 mm or 0.1 mm.

Other geometries of the bottom of the fluid handling structure are possible. For example, any of the structures disclosed in U.S. patent application publication no. US 2004-0207824 could be used in an embodiment of the invention.

The gas knife is desirably close enough to the openings 50 to create a pressure gradient across the space between them. There is desirably no stagnant zone in which a layer of liquid (i.e. a liquid film), or a liquid droplet can accumulate, for example beneath the fluid handling structure 12. In an embodiment, the flow rate of gas through the openings 50 may be coupled to the gas flow rate through the elongate aperture 61 as described in U.S. Patent Application Publication No. US 2010-0313974 and U.S. Patent Application Publication No. US 2007-0030464, which are each hereby incorporated by reference in their entirety. The gas flow may therefore be directed substantially inwardly from the aperture 61 to the openings 50. Where the gas flow rate through the openings 50 and the aperture 61 is the same, the flow rate may be referred to as ‘balanced’. A balanced gas flow is desirable as it minimizes the thickness of a liquid residue, e.g. film.

The aperture for the gas knife 61 may have a substantially similar shape as the shape formed by the openings 50. The separation between the edge of the shape formed by the openings 50 and the shape formed by the aperture 61 is within the aforementioned ranges. In an embodiment the separation is desirably constant.

The fluid soluble in the immersion liquid and arranged to reduce the surface tension of the meniscus of the immersion liquid may be present as a gas or in a form suspended in carrier gas (e.g. as a vapor of a liquid), or small droplets formed by an aerosol or atomization.

As shown in FIG. 7, a module for an immersion lithographic apparatus comprises the fluid handling structure 12. The module may comprise a source 350 of the fluid soluble in the immersion liquid for provision to the fluid supply opening 300.

In an embodiment, the module may comprise a carrier gas source 360. The carrier gas may be arranged to carry the fluid soluble in the immersion liquid from the source 350 to the fluid supply opening 300.

The fluid soluble in the immersion liquid and arranged to lower the surface tension of the meniscus of the immersion liquid can be any fluid which achieves the function of reducing the surface tension of the meniscus of the immersion liquid. In order to achieve this, the fluid will need to be soluble at least to some extent in the immersion liquid. Desirably the fluid has a solubility of greater than 10% in the immersion liquid. In an embodiment the fluid has a solubility of greater than 15, 20, 30 or even 40% in the immersion liquid. The fluid desirably has a lower surface tension than water. The fluid has a relatively high vapor pressure at operating temperature to ensure sufficient supply. The uptake of the vapor of the soluble fluid in water should be sufficiently fast. Suitable classes of chemicals are alcohols, ketones (for example acetone), aldehydes (for example formaldehyde), organic acids (for example acetic and formic acid), esters and amines (including ammonia). In general chemicals with a lower molecular weight (which generally give higher vapor pressure and water solubility) are desired. Desirably the soluble fluid has fewer than 10 carbon atoms per molecule, desirably fewer than 8, 6, 5, 4, 3 or even 2 carbon atoms per molecule. One example of the fluid is IPA (isopropyl alcohol). Another example of the fluid is ethanol. In an embodiment, the soluble fluid is a liquid with molecules which undergo hydrogen bonding; IPA and ethanol also have relatively low vapor pressures (i.e. small molecules).

In an embodiment the soluble fluid source 350 comprises a vessel of the fluid soluble in immersion liquid in liquid form. Vapor of that liquid (an aerosol or a cloud of atomized droplets formed from the liquid) is then transferred to the carrier gas from the carrier gas source 360 before being provided to the fluid supply opening 300. In an embodiment the carrier gas is bubbled through the vessel of fluid soluble in immersion liquid in liquid form. As the gas bubbles through the liquid, the vapor pressure in the carrier gas of the fluid soluble in immersion liquid will increase up to saturation. For IPA, saturation occurs at about 4½% by volume, if the carrier gas is nitrogen. Providing such a gas comprising nitrogen saturated with IPA (at about 4½% by volume) can result in a contact angle decrease of around 10 to 50° depending on the dissolution rate and residence time of the meniscus of immersion liquid, if the immersion liquid is ultra pure water. At such low concentrations it is not expected that the refractive index of the immersion liquid would change enough to result in imaging errors if the immersion liquid were to find its way into the patterned beam path. The energy of evaporation of IPA is lower than that of water but any evaporational load decrease would be counteracted by the increase in surface area. The carrier gas may be any gas, particularly inert gases such as nitrogen, argon, carbon dioxide, etc.

In an embodiment the soluble fluid is provided as a pure gas or mixture of gases.

In an embodiment the vessel of liquid has a permeable side wall 355. A flow of carrier gas along the side wall 355 is arranged on the other side of the permeable side wall 355 to the liquid. In this way, the vapor pressure of the soluble fluid increases in the carrier gas. In an embodiment the side wall may be in the form of a coil to maximize surface area.

In an embodiment, a spray of droplets of a surface tension reducing liquid can be provided out of the fluid supply opening 300 instead of a surface tension reducing gas.

A controller 500 is provided to control the various rates of extraction and provision through openings 50, 70, 61, 300 and 400. Flow sensors provide signals to the controller which sends signals to valves to vary flow rates. For example, the control may be automatic to achieve certain and/or user defined flow rates.

FIG. 8 shows the same view as FIG. 7 except that the facing surface (e.g. the substrate W) is moving under the fluid handling structure 12 from left to right as illustrated. This means that the meniscus 90 is an advancing meniscus and a leading edge of the fluid handling structure 12 is being viewed. As can be seen, droplet 310 on the substrate W is moved under the fluid supply opening 300. At this point fluid from the fluid supply opening 300 is dissolved into the liquid of the droplet 310 and the surface tension of the meniscus of the droplet 310 is decreased. Thus, the droplet reduces in height and flattens out. This means that the droplet 320 which then collides with the meniscus 90 has a lower height than would be the case in the absence of the fluid supply opening 300. The lower height of the droplet 320 means that it is less likely that a bubble will be included in the immersion liquid on collision of the droplet 320 with the meniscus 90.

FIG. 9 is the same as FIG. 8 except that it illustrates a receding meniscus 90 (i.e. a trailing edge of the fluid handling structure 12). When a droplet 330 breaks away from the meniscus 90, it has a large height. After the droplet 330 passes under the gas knife 61, it has fluid from the fluid supply opening 300 dissolved into it and thereby reduces the surface tension of its meniscus. As a result of the reduction in surface tension, the tall droplet 330 shrinks in height to a flat droplet 340. The flat droplet 340 is less likely to include bubbles into the immersion liquid on collision with the meniscus 90, has a more spread out heat load due to evaporation on the facing surface and, should the droplet result in any drying stains, these drying stains are less concentrated than they would otherwise be.

FIG. 10 is the same as FIG. 9 except that the operating conditions such as gas flow rate out of the gas knife 61 and/or fluid supply opening 300 of the fluid handling structure 12 is controlled according to variables such as scan speed and the soluble fluid and resist being used such that it leaves behind a film of immersion liquid. The film of immersion liquid is, in one embodiment, between 2 and 50 μm thick. Because of the presence of the fluid supply opening 300 and the concentration of the fluid dissolved in the immersion liquid, the film has a lower tendency to break up and form droplets compared to pure immersion liquid. Thus, a heat load due to evaporation is spread out and the number of droplet/meniscus collisions (which have a risk of a bubble being included in the immersion liquid) is reduced both due to the lower height of the film compared to droplets as well as the number of collisions being reduced due to the liquid being in the form of a film rather than a plurality of droplets. The film of FIG. 10 could be achieved by not shielding the meniscus 90 from the gas supply opening 300 and in certain circumstances this may be desirable. For example, the gas flow rate out of the gas knife 61 could be reduced or could be eliminated in order to achieve this. However, the fluid from the fluid supply opening 300 would affect the contact angle of the meniscus 90, reducing the contact angle and so possibly reducing the maximum scan speed which can be achieved with an acceptable liquid loss rate from the immersion space.

FIG. 11 schematically depicts in cross-section a part of a fluid handling structure 12 according to an embodiment of the invention. At the boundary between the space 11 in which the liquid is contained and a region that is external to the fluid handling structure 12, for example in the ambient atmosphere external to the fluid handling structure, a plurality of openings 50 and the aperture 61 may be arranged in the manner discussed above. A plurality of openings 50 may be arranged in a first line for use in extracting liquid from the space into the fluid handling structure 12. The aperture 61 may be provided in a second line and arranged to form a gas knife device. The gas from the gas knife may force liquid towards the openings 50 in the first line. In an embodiment of the invention, an elongate opening may be provided in the first line in place of the plurality of openings 50 for use in extracting liquid from the space into the fluid handling structure.

One or more openings 71 may be provided in a third line, or droplet line, further away from the immersion liquid than the first and second lines. A second gas knife device is formed by an aperture 72 arranged in a fourth line, or droplet knife line. (In an embodiment, the aperture 72 has a plurality of apertures 72). The fourth line is arranged to be further from the space 11 containing the immersion liquid than the third line. The gas flow through the second gas knife device may be mainly directed inwardly so that most of it passes through the one or more openings 71. In an embodiment the gas flow through the one or more openings 71 and the aperture 72 of the second gas knife device is balanced.

The fluid handling structure of this embodiment includes a first gas knife device operating in conjunction with a first plurality of openings 50. This combination performs the primary extraction of immersion liquid.

The fluid handling structure has a second gas knife device operating with the third line of openings 71. The provision of an additional combination of one or more openings and associated gas knife may be unexpectedly beneficial.

The provision in the fluid handling structure of two gas knife devices and associated openings for extraction permits the design and/or setting of process control parameters of each combination to be selected for the specific purpose of each combination, which may be different. The gas flow rate out of the aperture 61 in the second line, forming the first gas knife, may be less than the gas flow rate out of the aperture 72 in the fourth line forming the second gas knife device.

In an embodiment, a controller 63 is provided to control the rate of flow of gas through the aperture 61 in the second line. In an embodiment, the controller 63 may also control the rate of flow of gas through the openings 50 in the first line. The controller 63 may control an overpressure source 64 (e.g. a pump) and/or an underpressure source 65 (e.g. a pump, possibly the same pump as provides the overpressure). The controller 63 may be connected to one or more suitable flow control valves in order to achieve the desired flow rates. The controller may be connected to one or more two phase flow rate meters associated with one or more openings 50 to measure the extracted flow rate, a flow rate meter associated with the aperture 61 to measure the supplied gas flow rate, or both. A suitable arrangement for a two phase flow meter is described in U.S. Patent Application Publication No. US 2011-0013159 which is hereby incorporated by reference in its entirety.

A controller 73 (which may be the same as the controller 63) is provided to control the rate of flow of gas through the aperture 72. The controller 73 also controls the rate of flow of gas through the one or more openings 71. The controller 73 may control an overpressure source 74 (e.g. a pump) and/or an underpressure source 75 (e.g. a pump, possibly the same pump as provides the overpressure). There may be one or more suitable control valves connected to and controlled by the controller 73 in order to provide the desired flow rates. The controller may control the values based on flow measurements supplied by one or more two phase flow meters arranged to measure the flow through the one or more openings 71, one or more flow meters arranged to measure the flow through the aperture 72, or both. Such an arrangement may be similar to the arrangement for the flow components associated with the first and second lines.

In the embodiment depicted in FIG. 11, a recess 80 is provided in the lower surface 51 of the fluid handling structure. The recess 80 may be provided in a fifth line, or a recess line, between the second and third lines. In an embodiment, the recess 80 is arranged such that it is parallel to any of the first to fourth lines, desirably at least the second line, the third line or both.

The recess 80 may optionally include one or more openings 81 connected by a gas conduit 82 to atmosphere, such as the ambient atmosphere, for example to a region external to the fluid handling structure. The recess 80, desirably when connected to an external atmosphere, may function to decouple the first gas knife device and associated one or more openings 50 in the first line from the second gas knife device and associated one or more openings 71 in the third line. The recess 80 decouples the operation of the components located either side; so the features radially inward of the recess are decoupled from the features radially outward.

The embodiment of FIG. 11 may be varied by providing a flat surface between the inner gas knife 61 and the one or more outer extraction openings 71, or a step between them, or a sloped (desirably curved) surface between them and/or by omitting the inner gas knife 61 as taught in U.S. patent application Ser. No. 13/090311 filed 20 Apr. 2011, which is hereby incorporated in its entirety by reference.

A system as illustrated in FIG. 11 is described in detail in US Patent Application Publication No. US 2011-0090472, which is hereby incorporated in its entirety by reference. An embodiment of the present invention may be applied to such a system by providing the fluid supply opening 300 and the outlet opening 400 radially outwardly of the second gas knife 72, for example, as illustrated in FIG. 11. In an embodiment the fluid supply opening 300 and the outlet opening 400 may be provided radially outward of the aperture 61 and radially inward of the outer extraction opening 71, for example inward of the recess 80. In an embodiment there may be two sets of fluid supply opening 300 and outlet opening 400, one set each radially inward and outward of the outer extraction opening 71. In an embodiment, the soluble fluid is provided through the outer opening 71.

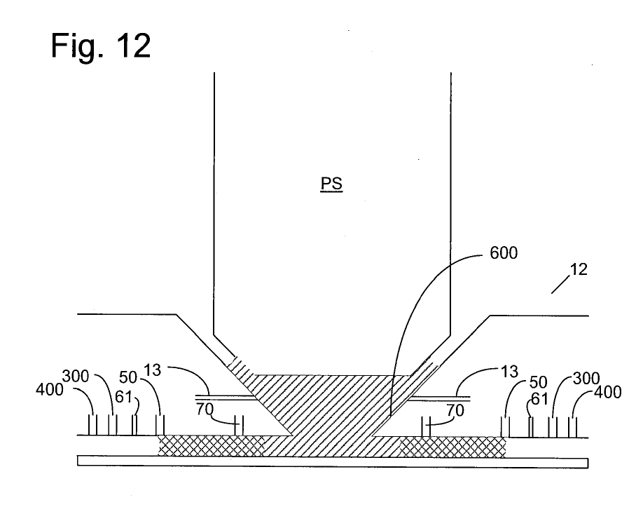

FIG. 12 illustrates a further embodiment of the fluid handling structure 12, in cross-section. The fluid handling structure 12 of FIG. 12 is the same as that of FIGS. 6 and 7 except as described below.

In FIG. 12, gas supply opening 300 or outlet opening 400 are not necessary (while shown in FIG. 12 as an optional feature, they may be omitted). Instead, the space filled with immersion liquid is filled with two different liquids. An immersion liquid enclosure, through which the patterned beam passes is defined by inner side wall 600 of the fluid handling structure 12, the facing surface (e.g. the substrate W) and the final element of the projection system PS. The side wall 600 that defines the side of the immersion liquid enclosure includes an opening 13 for the provision of immersion liquid into the immersion liquid enclosure.

The remainder of the space filled with liquid is part of the gap between the bottom surface 51 of the fluid handling structure 12 and the facing surface. This gap is filled with liquid from the liquid supply openings 70.

By arranging for a radially outward flow of liquid from the liquid supply opening 70 to the outlet 50, mixing of liquid in the immersion liquid enclosure with liquid from the gap can be substantially reduced. Therefore, it is possible to use a different liquid in the gap provided through the liquid supply opening 70 to the liquid provided to the immersion liquid enclosure through the opening 13. This allows both types of fluid to be optimized for their particular function.

In the case of fluid in the gap, it is desirable that droplets of liquid have a low height when they are left behind on the facing surface after passage underneath the fluid handling structure 12. As described above, a flat droplet is less likely to cause inclusion of a bubble on later collision with the meniscus 90 extending between the facing surface and the fluid handling structure 12. Therefore, the liquid provided by the supply opening 70 to the gap can be optimized to reduce the likelihood of bubble inclusion into the liquid in the immersion liquid enclosure by ensuring the liquid provides a low surface tension, for example. The liquid provided to the immersion fluid enclosure can be optimized for its optical properties. The liquid provided through the supply opening 70 does not necessarily need to be compatible with exposure to the patterned beam B because it does not substantially enter the immersion liquid enclosure, e.g., it is never illuminated by the patterned beam B. Desirably the two liquids are immiscible. A suitable liquid may be IPA, for example in the form of an aqueous solution of IPA. Any of the liquids which may be used to form the contact angle changing gas may be used as the liquid, for example in aqueous form.

In an embodiment, there is provided a fluid handling structure for a lithographic apparatus, the fluid handling structure successively having, at a boundary from a space configured to contain immersion fluid to a region external to the fluid handling structure: a meniscus pinning feature to resist passage of immersion fluid in a radially outward direction from the space; and a fluid supply opening radially outward of the meniscus pinning feature to supply a fluid soluble in the immersion fluid which on dissolution into the immersion fluid lowers the surface tension of the immersion fluid.

In an embodiment, the fluid handling structure comprises a shielding device to shield immersion fluid in the space from the soluble fluid exiting the fluid supply opening. In an embodiment, the shielding device comprises the meniscus pinning feature. In an embodiment, the shielding device comprises a gas knife, desirably with a gas flow rate of lower than 100 l/min/m. In an embodiment, the shielding device is radially inward of the fluid supply opening. In an embodiment, the meniscus pinning feature is constructed and arranged to form a radially outward flow of immersion fluid at an edge of the space and the immersion fluid is a liquid. In an embodiment, the meniscus pinning feature comprises a plurality of extraction openings, in a line at least partly surrounding the space, to extract gas and/or liquid from outside the fluid handling structure therethrough. In an embodiment, the fluid handling structure further comprises a liquid supply opening radially inward of the meniscus pinning feature to supply liquid to the space. In an embodiment, the fluid supply opening is configured to supply the soluble fluid in gaseous form. In an embodiment, the fluid handling structure further comprises an outlet opening radially outward of the fluid supply opening, the outlet configured to extract therethrough gas from the fluid supply opening, and desirably the soluble fluid is supplied in a gas. In an embodiment, the outlet opening is in a member separate to the member in which the meniscus pinning feature is formed and/or the outlet opening is in a member separate to the member in which the fluid supply opening is formed. In an embodiment, the fluid supply opening is in a member separate to the member in which the meniscus pinning feature is formed. In an embodiment, the fluid handling structure is constructed and arranged to leave behind on a surface which moves under the fluid handling system a film of immersion fluid in which fluid from the fluid supply opening is dissolved.

In an embodiment, there is provided a module for an immersion lithographic apparatus, the module comprising a fluid handling structure as described herein.

In an embodiment, the module further comprises a soluble fluid source of a fluid soluble in the immersion fluid and which upon dissolution in the immersion fluid lowers the surface tension of a meniscus of the immersion fluid and arranged to be provided to the fluid supply opening. In an embodiment, the soluble fluid source is a source of a fluid which has a solubility of greater than 10%, greater than 15% or greater than 20% in the immersion fluid. In an embodiment, the soluble fluid source is a source of one or more chemicals selected from the group including: alcohol, ketone, aldehyde, organic acid, ester, amine. In an embodiment, the soluble fluid source is a source of IPA or ethanol. In an embodiment, the soluble fluid source comprises a vessel of the soluble fluid in liquid form which is soluble in immersion fluid. In an embodiment, the vessel comprises an inlet to introduce a carrier gas for bubbling through the soluble fluid. In an embodiment, the vessel comprises a permeable side wall and is arranged to flow a carrier gas on a side of the permeable side wall opposite to the liquid of the soluble fluid. In an embodiment, the module further comprises a carrier gas source of a gas to be provided with the soluble fluid. In an embodiment, the module further comprises a controller configured to control a fluid flow rate into and/or out of the fluid handling structure. In an embodiment, the module further comprises a source of immersion fluid.

In an embodiment, there is provided a lithographic apparatus comprising the fluid handling structure or module described herein.

In an embodiment, there is provided a fluid handling structure for a lithographic apparatus, the fluid handling structure successively having, at a boundary from a space configured to contain immersion fluid to a region external to the fluid handling structure: a gas knife to resist passage of immersion fluid in a radially outward direction from the space; and a surface tension lowering fluid opening to provide a surface tension lowering fluid radially outward of the gas knife.

In an embodiment, a gas flow rate of gas through the gas knife is lower than 100 l/min/m. In an embodiment, the fluid handling structure further comprises a plurality of extraction openings, in a line at least partly surrounding the space, to extract gas and/or liquid from outside the fluid handling structure therethrough. In an embodiment, the plurality of extraction openings are radially inwardly of the gas knife and a gas flow rate out of the gas knife is greater than of the combined gas flow rate into the plurality of extraction openings. In an embodiment, the fluid handling structure further comprises an outlet opening radially outwardly of the surface tension lowering fluid opening for the extraction therethrough of fluid from the surface tension lowering fluid opening. In an embodiment, the surface tension lowering fluid opening is constructed and arranged to provide a spray of a liquid radially outward of the gas knife.

In an embodiment, there is provided a fluid handling structure for a lithographic apparatus, the fluid handling structure having: an inner side wall defining a side of an immersion liquid enclosure with a bottom of the immersion liquid enclosure defined, in use, by a facing surface; a first opening in the inner side wall to provide immersion liquid to the immersion liquid enclosure; a second opening in a bottom wall of the fluid handling structure, which, in use, faces the facing surface, to provide a liquid with a lower surface tension to the immersion liquid to a gap between the fluid handling structure and the facing surface; and a meniscus pinning feature resisting passage of liquid in a radially outward direction along the gap, wherein the meniscus pinning feature is radially outward of the second opening.

In an embodiment, the meniscus pinning feature is constructed and arranged to form a radially outward flow of immersion liquid in the gap. In an embodiment, the meniscus pinning feature comprises a plurality of extraction openings, in a line at least partly surrounding the space, to extract gas and/or liquid from outside the fluid handling structure therethrough. In an embodiment, the meniscus pinning feature comprises a gas knife radially outward of the plurality of extraction openings. In an embodiment, liquid exiting the second opening is IPA or ethanol.

In an embodiment, there is provided a device manufacturing method comprising projecting a patterned beam of radiation through an immersion liquid confined by a meniscus pinning feature on to a substrate, and supplying a fluid soluble in the immersion liquid which on dissolution into the immersion liquid lowers the surface tension of the immersion liquid at a position radially outward of the meniscus pinning feature.

In an embodiment, there is provided a device manufacturing method comprising projecting a patterned beam of radiation through an immersion liquid confined to a space by a gas knife onto a substrate positioned on a table and lowering surface tension of the immersion liquid radially outward of the gas knife by providing a surface tension lowering fluid radially outwardly of the gas knife.

In an embodiment, there is provided a device manufacturing method comprising: projecting a patterned beam of radiation through an immersion liquid onto a substrate, wherein the immersion liquid is provided to an immersion fluid enclosure defined by an inside wall of a fluid handling structure and the substrate; and providing a second liquid with a lower surface tension to the immersion liquid to a gap between the fluid handling structure and the substrate at a position radially inwardly of a meniscus pinning feature of the fluid handling structure.

As will be appreciated, any of the above described features can be used with any other feature and it is not only those combinations explicitly described which are covered in this application.

Although specific reference may be made in this text to the use of lithographic apparatus in the manufacture of ICs, it should be understood that the lithographic apparatus described herein may have other applications in manufacturing components with microscale, or even nanoscale features, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described above may have any suitable configuration for receiving, processing, and sending signals. For example, each controller may include one or more processors for executing the computer programs that include machine-readable instructions for the methods described above. The controllers may also include data storage medium for storing such computer programs, and/or hardware to receive such medium.

One or more embodiments of the invention may be applied to any immersion lithography apparatus, in particular, but not exclusively, those types mentioned above, whether the immersion liquid is provided in the form of a bath, only on a localized surface area of the substrate, or is unconfined on the substrate and/or substrate table. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. A fluid handling structure for a lithographic apparatus, the fluid handling structure successively having, at a boundary from a space configured to contain immersion fluid to a region external to the fluid handling structure:
a meniscus pinning feature to resist passage of immersion fluid in a radially outward direction from the space; and
a fluid supply opening radially outward of the meniscus pinning feature to supply a fluid soluble in the immersion fluid which on dissolution into the immersion fluid lowers the surface tension of the immersion fluid.

2. The fluid handling structure of claim 1, wherein the meniscus pinning feature is constructed and arranged to form a radially outward flow of immersion fluid at an edge of the space and the immersion fluid is a liquid.

3. The fluid handling structure of claim 2, wherein the meniscus pinning feature comprises a plurality of extraction openings, in a line at least partly surrounding the space, to extract gas and/or liquid from outside the fluid handling structure therethrough.

4. The fluid handling structure of claim 1, further comprising an outlet opening radially outward of the fluid supply opening, the outlet configured to extract therethrough gas from the fluid supply opening.

5. The fluid handling structure of claim 4, wherein the outlet opening is in a member separate to the member in which the meniscus pinning feature is formed and/or the outlet opening is in a member separate to the member in which the fluid supply opening is formed.

6. The fluid handling structure of claim 1, comprising a shielding device to shield immersion fluid in the space from the soluble fluid exiting the fluid supply opening.

7. The fluid handling structure of claim 6, wherein the shielding device comprises the meniscus pinning feature.

8. The fluid handling structure of claim 6, wherein the shielding device comprises a gas knife.

9. The fluid handling structure of claim 6, wherein the shielding device is radially inward of the fluid supply opening.

10. The fluid handling structure of claim 1, wherein the fluid supply opening is configured to supply the soluble fluid in gaseous form.

11. The fluid handling structure of claim 1, wherein the fluid supply opening is in a member separate to the member in which the meniscus pinning feature is formed.

12. The fluid handling structure of claim 1, constructed and arranged to leave behind on a surface which moves under the fluid handling system a film of immersion fluid in which fluid from the fluid supply opening is dissolved.

13. A module for an immersion lithographic apparatus, the module comprising a fluid handling structure according to claim 1.

14. The module of claim 13, further comprising a soluble fluid source of a fluid soluble in the immersion fluid and which upon dissolution in the immersion fluid lowers the surface tension of a meniscus of the immersion fluid and arranged to be provided to the fluid supply opening.

15. The module of claim 14, wherein the soluble fluid source is a source of one or more chemicals selected from the group including: alcohol, ketone, aldehyde, organic acid, ester, or amine.

16. A fluid handling structure for a lithographic apparatus, the fluid handling structure successively having, at a boundary from a space configured to contain immersion fluid to a region external to the fluid handling structure:
a gas knife to resist passage of immersion fluid in a radially outward direction from the space; and
a surface tension lowering fluid opening to provide a surface tension lowering fluid radially outward of the gas knife.

17. A fluid handling structure for a lithographic apparatus, the fluid handling structure having:
an inner side wall defining a side of an immersion liquid enclosure with a bottom of the immersion liquid enclosure defined, in use, by a facing surface;
a first opening in the inner side wall to provide immersion liquid to the immersion liquid enclosure;
a second opening in a bottom wall of the fluid handling structure, which, in use, faces the facing surface, to provide a liquid with a lower surface tension to the immersion liquid to a gap between the fluid handling structure and the facing surface; and
a meniscus pinning feature resisting passage of liquid in a radially outward direction along the gap, the meniscus pinning feature being radially outward of the second opening.

18. A device manufacturing method comprising:
projecting a patterned beam of radiation through an immersion liquid confined by a meniscus pinning feature on to a substrate; and
supplying a fluid soluble in the immersion liquid which on dissolution into the immersion liquid lowers the surface tension of the immersion liquid at a position radially outward of the meniscus pinning feature.

19. A device manufacturing method comprising:
projecting a patterned beam of radiation through an immersion liquid confined to a space by a gas knife onto a substrate positioned on a table; and
lowering surface tension of the immersion liquid radially outward of the gas knife by providing a surface tension lowering fluid radially outwardly of the gas knife.

20. A device manufacturing method comprising:
projecting a patterned beam of radiation through an immersion liquid onto a substrate, wherein the immersion liquid is provided to an immersion fluid enclosure defined by an inside wall of a fluid handling structure and the substrate; and
providing a second liquid with a lower surface tension to the immersion liquid to a gap between the fluid handling structure and the substrate at a position radially inwardly of a meniscus pinning feature of the fluid handling structure.
